(19) United States
(12) Patent Application Publication
(10) Pub. No.: US 2012/0233584 A1
(43) Pub. Date: Sep. 13, 2012

(54) Analysis of Interactions of C and C++ Strings

(75) Inventors: Franjo Ivancic, Princeton, NJ (US); Gogul Balakrishnan, Princeton, NJ (US); Naoto Maeda, Tokyo (JP); Aarti Gupta, Princeton, NJ (US)

(73) Assignee: NEC LABORATORIES AMERICA, INC., Princeton, NJ (US)

(21) Appl. No.: 13/416,358

(22) Filed: Mar. 9, 2012

Related U.S. Application Data
(60) Provisional application No. 61/450,853, filed on Mar. 9, 2011.

(51) Int. Cl. G06F 9/44

(52) U.S. Cl. 717/104

(57) ABSTRACT

A computer implemented method for analyzing a computer software program comprising both C++ and C string components, wherein the method includes building a memory model abstraction of any memory used by the program strings. Various memory models are presented that find invalid memory accesses in terms of validity of memory regions and buffer overflows. The model supports analyzing the interaction of C and C++ components—in particular, it focuses on the interaction of C and C++ strings. The conversion of C++ strings to C strings is accomplished through a non-transferable ownership attribute that is to be respected by the C strings. The models can then be analyzed using static analysis techniques such as abstract interpretation and model checking, or through dynamic analysis. In so doing we allow discovery of potential memory safety violations in programs involving conversions between C and C++ strings.

### CROSS REFERENCE TO RELATED APPLICATION

This application claims the benefit of U.S. Provisional Patent Application No. 61/450,853 filed Mar. 9, 2011 which is hereby incorporated by reference as if set forth at length herein.

### TECHNICAL FIELD

This disclosure relates generally to the field of computer software and in particular to methods for analyzing and determining invalid buffer accesses by computer programs exhibiting interacting C and C++ strings.

### BACKGROUND

Strings are commonly used in a large variety of computer software. Despite their pervasiveness, they are a common source of bugs oftentimes involving invalid memory accesses arising from misuses of string manipulation application programming interface(s) (API). These bugs are oftentimes exploitable remotely-leading to serious consequences. Accordingly, the static detection of invalid memory accesses due to string manipulations has received much attention in the art, especially for C programs using standard C library functions.

More recently, software development is increasingly being performed in object-oriented languages such as C++ and Java. However, the need to interact with legacy C code and C-based system-level APIs often necessitates the use of a mixed programming paradigm that combines features of high-level object-oriented constructs with calls to standard C library functions. While such mixed-paradigm programs have become common, there remains a continuing need in the art for methods that provide static analysis of such code in an attempt to uncover and eliminate bugs.

### SUMMARY

An advance in the art is made according to an aspect of the present disclosure directed to a computer implemented method for analyzing a computer software program comprising both C++ and C string components, wherein the method includes building a memory model abstraction of any memory used by the program strings; modeling the C++ strings as C strings wherein the modeled C++ strings are given a non-transferable ownership attribute that is respected by the C strings; verifying the model; and outputting any violations.

### BRIEF DESCRIPTION OF THE DRAWING

A more complete understanding of the present disclosure may be realized by reference to the accompanying drawings in which:

FIG. 1 is a code excerpt of a motivating example according to an aspect of the present disclosure;

FIG. 2 shows a set of main analysis components for a method according to an aspect of the present disclosure;

FIG. 3 shows a exemplary memory model for pointer bounds model after executing certain statements;

FIG. 4 shows a code excerpt depicting partial string object validity model sketch according to an aspect of the present disclosure;

FIG. 5 shows a code excerpt depicting the interaction of C and C++ strings according to an aspect of the present disclosure;

FIG. 6 shows (a) updates to the validity status for the simplified code shown in FIG. 5, assuming that the input string was initially allocated on the stack; and (b) updates to the validity status for another sequence of statements shown in the column labeled stmt;

FIG. 7 shows a program excerpt depicting an array bound model for the string::c_str method;

FIG. 8 shows a program excerpt depicting invalid string manipulation;

FIG. 9 shows a program excerpt depicting potential buffer overflow;

FIG. 10 shows a program excerpt depicting Erlang/OTP Orber application code;

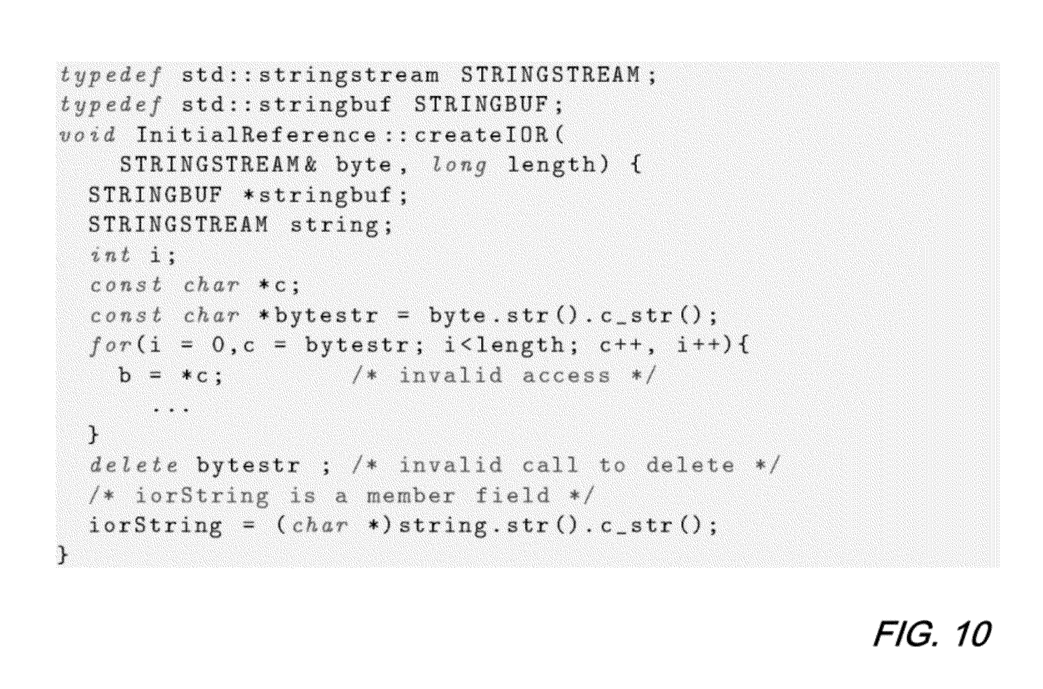

FIG. 11 is a schematic depicting a high level overview of a tool chain according to an aspect of the present disclosure; and

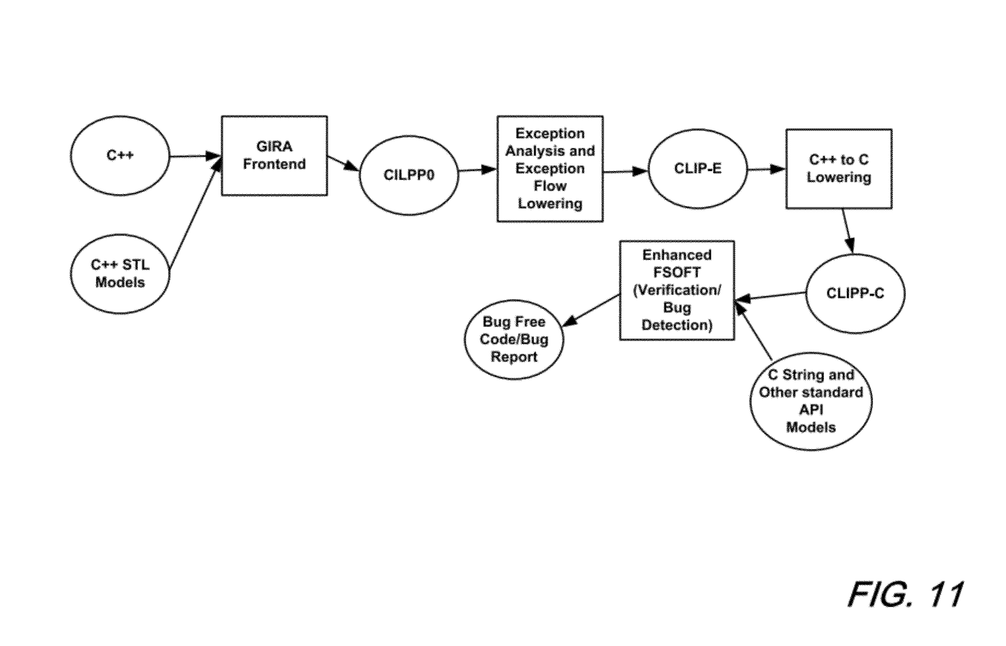

FIG. 12 is a schematic diagram depicting an exemplary computer system upon which methods according to the present invention may be executed.

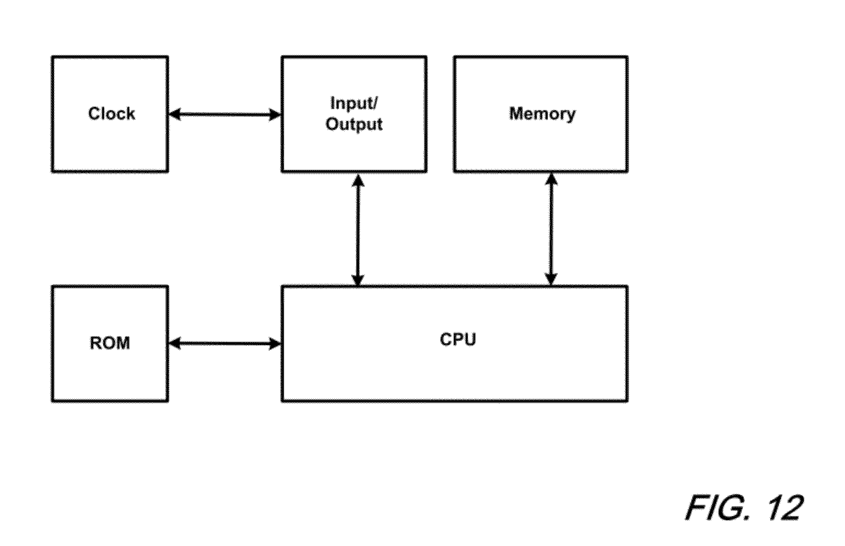

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

By way of some additional background and as those skilled in the art will readily appreciate and understand, buffer overflows are common in systems code. They can lead to memory corruption and application crashes. They are particularly dangerous if they can be exploited by malicious users to deny service by crashing a system or escalate privileges remotely. A large number of overflows are known to be present in deployed commercial as well as open-source software. Accordingly, a significant volume of research on buffer overflow prevention has focused on the detection of overflows in C code.

Software development teams have shifted their development from C to object-oriented languages including C++ and Java. The benefits of using an object-oriented language include reusability, better maintainability, encapsulation and the use of inheritance. In particular, C++ is often chosen due to its ability to interact with legacy C-based systems, including system-level C libraries. Thus, development in C++ often necessitates a mixed programming style combining object-oriented constructs with lower-level C code. Whereas a large volume of work on verification has focused on C programs, there has been comparatively little work on the verification of C++ programs.

The modeling of objects in the heap is a key component of such verification. According to aspects of the present disclosure then, we present heap-aware static analysis techniques that can verify memory safety of C/C++ programs. Advantageously, methods according to the present disclosure satisfactorily model strings in C/C++ and buffer overflow errors.

### Motivating Example

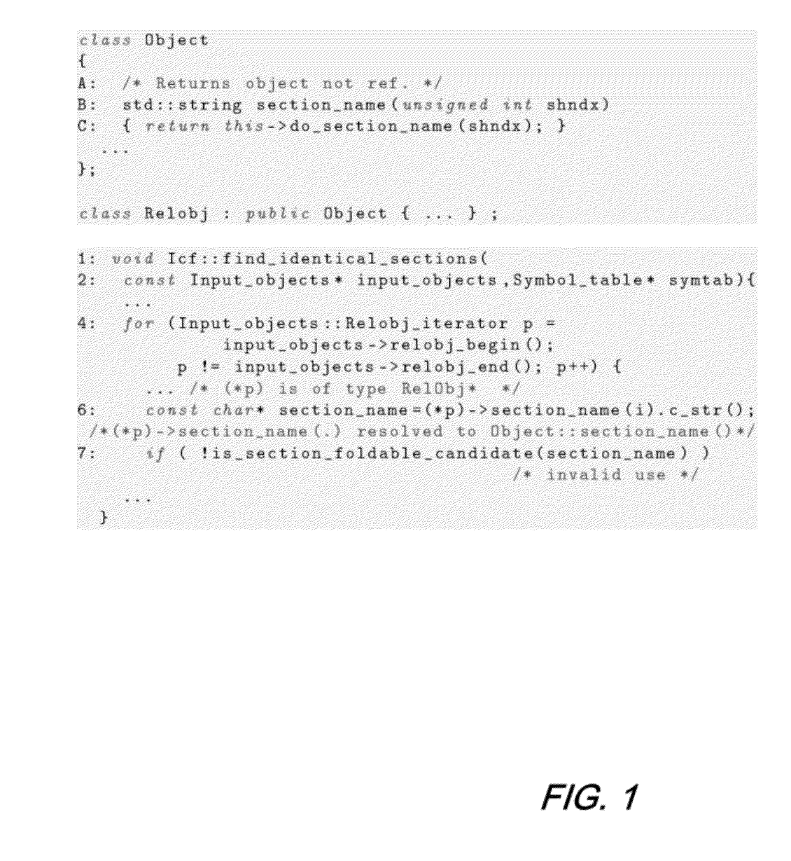

With reference now to FIG. 1, there is shown a program excerpt exhibiting a typical “interaction bug”. The code excerpt is taken from the known gold project, part of the GNU binutils (binary utilities) package (v2.21). Gold is a linker that is more efficient for large C++ programs than the standard GNU linker. For convenience, we have added labels to denote line numbers of interest.

Consider the call to c_str( ) in line 6 of the function find_identical_sections. The call (*p)->section_name(i) creates a temporary object (see labels A-C in class Object). The call to the c_str( ) method thus obtains a pointer to a C string, pointing into the temporary object. However, the subsequent uses of that string, stored in the variable section_name, are invalid. The temporary object (including the pointed to C string) is destroyed immediately following the call to c_str( ). Under certain conditions the freed memory may be re-used, leading to segmentation fault or memory corruption. Thus, the call to is section_foldable_candidate( ) and further uses of the variable not shown here, produce unexpected behavior.

This example shows some typical C++ code. Note that just considering the call to c_str( ) is not enough to find this bug. If Object::section_name( ) (lines A-C) had returned a reference, this use of c_str( ) would likely have been legal. Due to the hidden side effects in C++ and the interaction with legacy C APIs, such bugs are easy to commit and hard to find. Furthermore, the bug in binutils had gone unnoticed for at least a year in spite of rigorous testing (the bug was introduced before the release of v2.20, which was officially released in October 2009).

It is likely that under normal runtime deployment or during unit testing, the pointer assigned to section_name still contains the original string even after it is destroyed. However, under large resource constraints, this bug may manifest itself likely through a segmentation fault upon a later use of section_name. Finally, note that a static analysis needs to handle numerous C++ specific issues including STL classes, complex inheritance, and iterators.

### Our Approach.

Given a program and the properties to check, we use an abstraction to model the memory used by arrays, pointers, and strings. The memory model abstraction only tracks the attributes and operations that are relevant to the properties under consideration. We focus on providing precise and scalable memory model for the usage of C and C++ strings. In particular, we address the intricate interplay between C and C++ strings.

Instead of providing a universal memory model, we partition the set of potential bugs into various classes, and use different models for the different classes. Tailoring the memory models to the class of bugs makes the analysis and verification more scalable. For instance, while checking for NULL-pointer dereferences and use-after-free bugs, we use an abstraction that only tracks the status of the pointer, and does not keep track of buffer sizes and string lengths. On the other hand, we use a more precise analysis model that keeps track of allocated memory regions and string lengths for checking buffer overflows.

One particular distinguishing feature of memory models according to aspects of the present disclosure is that our models provide a unified framework that addresses correct usage of C-based strings, the C++ STL string class, as well as the interaction between the C++ string class and C strings through conversions from one to the other. Whereas heap aware models for C programs have been well studied, our model handles C++ objects including memory allocation using new/delete, the string class in STL and the interaction of these features in C++. To deal with the interaction of C and C++ strings, we introduce a notion of non-transferable ownership of a C-string. We utilize this ownership notion to find dangling pointer accesses of C-strings that were obtained through a conversion from a C++ string.

The memory models are weaved into the program under consideration and are then verified using various static analysis and model checking techniques. First, we employ abstract interpretation to prove properties using a variety of numerical abstract domains. The proved properties are eliminated, which enables us to simplify the model of the program. Then, we use a model checker, in particular a bit-accurate SAT-based bounded model checker, to find proofs and violations for the remaining properties. The model checker outputs concrete witnesses that demonstrate (a) the path taken through the program to produce the violation and (b) concrete values for the program variables.

As those skilled in the art will readily appreciate, methods according to the present disclosure advantageously:

are sophisticated, yet scalable, heap-aware memory models for analyzing overflow properties of C and C++ programs that use features including arrays, strings, pointer arithmetic, dynamic allocation, multiple inheritance, exceptions, casting, and standard library usage;

tackle the interaction of C and C++ strings, thus enabling our tool to discover subtle bugs in the interaction between the different string kinds We separate the checks into two classes: a pointer-validity-based checking class and a string-length-based checking class. We also introduce a notion of non-transferable ownership or origination of a C-string for strings obtained through conversion from the C++ string class;

have been implemented and demonstrated their usefulness on real code, where we found previously unknown bugs in open-source software. To find these bugs, our tool uses abstract interpretation for proving properties and bit-precise model checking for finding concrete witness traces.

### Overview of Analysis Framework

Previously, we have developed and reported a general analysis framework for C programs called F-Soft. It uses both abstract interpretation and bounded model checking to find bugs in the source code under analysis.

F-Soft contains a number of “checkers” for various memory safety issues. These include a memory leak checker (MLC), a pointer validity checker (PVC) and an array buffer overflow checker (ABC). These checkers use different levels of abstraction, and thus, explore different trade-offs between scalability and their ability to reason about intricate pointer accesses.

For example, PVC targets bugs such as use-after-free, accesses of a NULL pointer, freeing of a constant string, etc. On the other hand, ABC targets violations that require reasoning about sizes of arrays and strings, and whether strings are null-terminated. To improve scalability of ABC, properties that could be checked using PVC are not considered by ABC.

For the purposes of this disclosure, we omit discussion of other checkers available in our tool for sake of brevity. These include checkers for the use of uninitialized memory (UUM) and an exception analysis (EXC) that computes exceptional control flow paths in C++ programs, for example. The EXC checker can also find uncaught exception violations [33]. Ultimately, all checkers generate a model of the program with embedded properties that can be checked by the subsequent analysis engines.

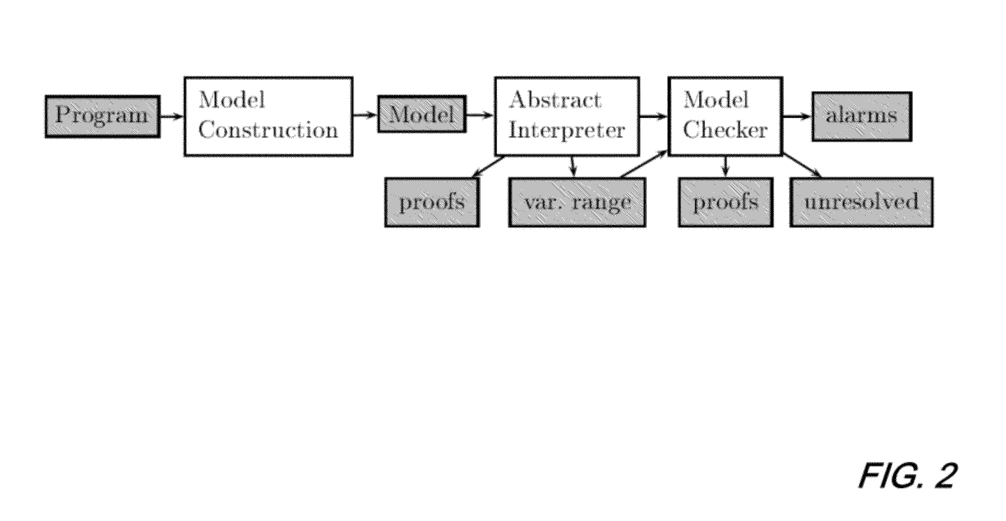

FIG. 2 depicts the major analysis modules used in our tool according to aspects of the present disclosure. The overall flow is geared towards maximizing the number of property proofs and concrete witnesses of property violations.

More particularly, after model construction for a given program, we analyze the model using abstract interpretation in an attempt to prove that assertions are never violated. Assertions that can be proved safe are removed from the model, and the final model is sliced based on the checks that remain unresolved. In practice, the sliced model is considerably smaller than the original.

The model is then analyzed by a series of model-checking engines, including a SAT-based bounded model checker. At the end of model checking, we obtain concrete traces that demonstrate property violations in the model. These violations are mapped back to the source code and displayed using an HTML-based interface or a programming environment such as Eclipse™.

We may now briefly describe the major components in the flow.

### Abstract Interpreter

Abstract interpretation is used in our flow as the main proof engine. Our abstract interpreter is inter-procedural, flow- and context-sensitive. Currently, we have implementations of abstract domains such as constants, intervals, octagons, and polyhedra. These domains are organized in increasing order of complexity. After each analysis is run, the proved properties are removed and the model is simplified using slicing. The resulting model is then analyzed by a more complex domain.

Invariants computed at each program point are used to infer safe intervals for the program variables. The intervals thus computed restrict the domain of these variables and are utilized by the model checker. Typically, the abstract interpretation and the simplifications use less than 10% of the total analysis time. The remaining 90% is used by the model checking engines.

### Model Checker

The model checker creates a finite state machine model of the simplified program after abstract interpretation. Each integer variable is treated as a 32 bit entity, character variables as 8 bits and so on. However, the range information provided by the abstract interpreter for program variables is used to reduce the number of bits significantly. We use bit-accurate representations of all operators, ensuring that arithmetic overflows are modeled faithfully.

The model checker verifies the symbolic model for the reachability of the embedded properties. We primarily use SAT-based bounded model checking. This technique unrolls the program up to some depth d>0 and searches for the presence of a bug at that depth by compilation into a SAT problem. The depth d is increased iteratively until a bug is found or resources run out. The model checker generates a counterexample (witness trace) which vastly simplifies the user inspection and evaluation of the error.

### Performance

The performance of our tool may be measured in terms of its scalability and number of real bugs found vs. the number of false positives. Our precise treatment of pointer and string operations guarantee that false positives due to modeling limitations are kept as small as possible. However, there are definite limits to the scalability of this approach. As with other verification tools, scalability depends on the nature of the program. There is in general a wide variability in the behavior of our tool depending on the amount of string usage, the use of pointers, heap, the number of structure fields and so on. So far, we have run various versions of our tool cumulatively on multiple MLOC of open source and industrial source code.

### C++ String Class Usage Issues

C++ STL strings provide a safer alternative to developers when compared to C strings. However, as shown in the motivating example (see FIG. 1), mistakes are still easy to make, especially in the interaction with C-based standard library functions. The string class contains a number of built-in features such as modification routines (append, replace, etc), operations such as substring generation, iterators, and others. Additionally, the methods c_str( ) and data( ) can be called to obtain a buffer containing a C string, which is null-terminated for c_str( ) and not null-terminated for data( ).

Advantageously, our description focuses on the c_str( )method, but is applicable to data( ) as well. Moreover, the data( ) method is even more error-prone due to it returning a non null-terminated string. We classify common bugs related to the use of strings as follows below:
1. Generic bugs: Memory leaks, uncaught exceptions (eg., std::bad_alloc) [33].
2. String class manipulation errors:
   (a) Out of bounds access. std::out_of_range exception thrown by the at and operator[ ] methods of the string class.
   (b) Use of a string object after it has been destroyed.
   (c) Use of a stale string iterator.
3. Interaction between C and C++ strings [(a)]
   (a) Access of C-string returned by string::c_str( ) after the corresponding C++ object is destroyed.
   (b) Certain C library functions called on strings obtained through c_str( ).
   (c) Manipulation of a C-string returned by string::c_str( ).
   (d) C-based buffer overflows on C-string obtained through string::c_str( ).

### Program Modeling and Memory Checkers

We now discuss the memory models used in our approach according to aspects of the present disclosure. Our approach supports a hierarchy of memory models ranging from models that simply track few bits of allocation status for each pointer to the full-fledged tracking of allocated bounds, string sizes, region aliasing of arrays, and so on. We describe two models within this spectrum: the pointer validity model that uses simple pointer type states, and the pointer bounds model that attempts to track allocated bounds, positions of various sentinels, and contents of cells accurately.

### Pointer Validity Model

The validity model instruments for each pointer a validity status (p) to denote the type of the location pointed-to in memory. These values include null indicating a null pointer; invalid for a non-NULL pointer whose dereference may cause a segmentation violation; static for pointers to global variables, arrays and static variables; stack for pointers to local variables, alloca calls, local arrays, formal arguments; heap for pointers to dynamically allocated memory on the heap; and code for code sections, such as string constants.

The validity model does not track addresses of pointers. It also ignores address arithmetic. A pointer expression p+i has the same validity status as its base pointer p. A dereference * p yields an assertion check that is violated if (p) is null or invalid. Similarly, relevant checks are done for other operations. We distinguish between null and invalid in order to allow delete NULL, which is allowed per C++ standard, as well as optionally allow free(NULL), which is handled gracefully by standard compilers such as gcc. Finally, note that it is easy to extend this model to find invalid de-allocations, such as the case where memory that was allocated using new is released using free. This can be accomplished by separating the validity status heap into sub-regions according to their allocation method, such as heap—malloc, heap—new and heap—new[ ].

### Pointer Bounds Model

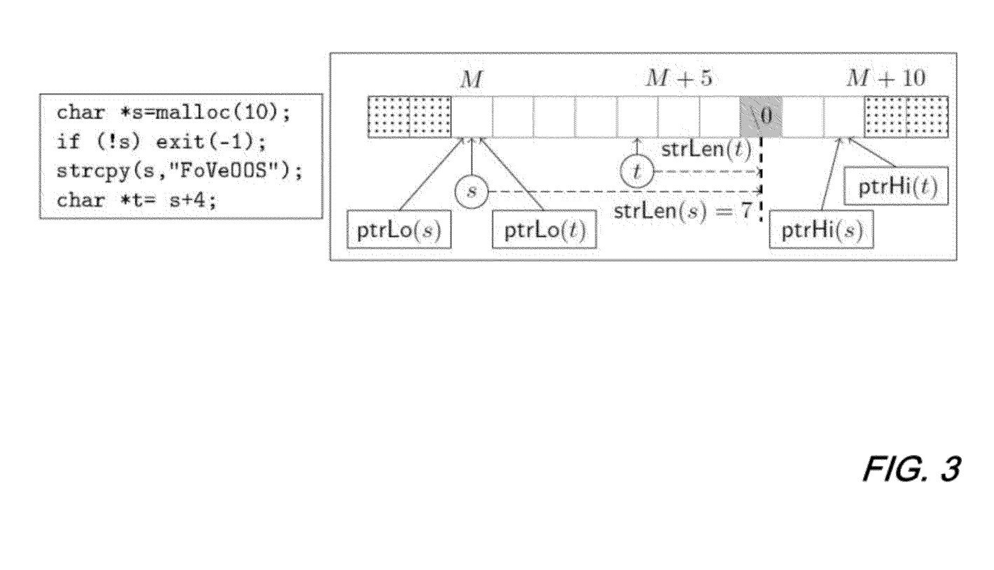

The bounds model tracks various attributes for each pointer, including allocation sizes and sentinel positions, which subsumes information tracked by the validity model. For a pointer p, the main modeling attributes are as follows (see FIG. 3):
1. ptrLo(p), which corresponds to the base address of a memory region that p currently points to;
2. ptrHi(p),which corresponds to the last address in the memory region currently pointed to by p that can be accessed without causing a buffer overflow;
3. strLen(p),which corresponds to the remaining string length of the pointer p, which is the distance to the next null-termination symbol starting at p.

For each pointer p, we track its “address”, and its bounds [(p), (p)], representing the range of values of the pointer p such that p may be legally dereferenced in our model. If pε[(p),(p)] then p[i] underflows iff p+i<(p). Similarly, p[i] overflows iff p+i>(p).

### Dynamic Allocation

We assign bounds for dynamic allocations with the help of a special counter pos(L) for each allocation site L in the code. It keeps track of the maximum address currently allocated. Upon each call to a function such as p:=malloc(n), our model assigns the variable pos(L) to p and (p). It increments pos(L) by n, and sets (p)+1 to this value.

### C String Modeling

Conventionally, strings in C are represented as an array of characters followed by a special null-termination symbol. String library functions such as strcat, and strcpy rely on their inputs to be properly null-terminated and the allocated bounds to be large enough to contain the results. We extend our model to check for such buffer overflows using a size abstraction along the lines of CSSV. The major differences are described later.

For each character pointer p, we use an attribute (p) to track the position of the first null-terminator character starting from p. The updates to string length can be derived along similar lines as those for the pointer bounds. For instance, calls to the method strcat that append its second argument to the first lead to assertion checks in terms of the pointer bounds and string lengths that guarantee its safe execution. Next, the update to the attribute of the first argument is instrumented. Our approach currently has instrumentation support for about 650 standard library functions. It provides support for parsing constant format strings in order to model effects of functions such as sprintf. We elide the details for lack of space and focus here on the modeling of C++ strings and their interaction with C. Instead, we use the following example to present certain aspects of this modeling.

### Modeling the STL String Class

We now present a model for C++ strings that allows us to capture common bugs arising from the misuse of STL strings. Note that, for the sake of brevity, we omit the presentation of string iterator related issues in this paper. Furthermore, we will not discuss issues due to uncaught exceptions when utilizing the C++ string class. Details on our exception handling can be found elsewhere.

As described above, we separate verification into a light-weight pointer validity-based checker and a more heavy-weight buffer overflow checker tracking accurate string lengths using an extension of the pointer bounds model. Finally, it should be noted that we model a wider class of C++ STL strings than alluded to so far. For example, we also model the templated class std::basic_string<T>, of which std::string is just a particular instantiation.

Pointer and String Object Validity

Previously, we introduced a memory model that focuses on validity of pointers. Here, we extend it by introducing a new validity status that is used to model the interaction of C++ strings with C-based strings. We check most issues related to the interaction of C++ and C strings by developing an extended pointer and string object validity checker rather than additionally burdening the pointer bounds model. To do so, we model calls to string::c_str( ) such that they return C strings whose validity status is set to a new status that behaves roughly like the code status, denoting constant strings. A key difference is that the owning class instance, which returned the string in the first place, is allowed to manipulate this string, while no manipulations are permissible for constant strings.

TABLE 1
Overview of Pointer and String Object Validity Model

| status | * | free | delete | delete[ ] | if-NULL | return | ( ) |
|---|---|---|---|---|---|---|---|
| null | [symbol] | ( [symbol] ?) null | null | null | null | null | [symbol] |
| invalid | [symbol] | [symbol] | [symbol] | [symbol] | [symbol] | invalid | [symbol] |
| stack | stack | [symbol] | [symbol] | [symbol] | N/A | invalid | invalid |
| global | global | [symbol] | [symbol] | [symbol] | N/A | global | [symbol] |
| code | [symbol] on | [symbol] | [symbol] | [symbol] | N/A | code | [symbol] |
| | write | | | | | | |
| env. | env. | invalid | invalid | invalid | null | env. | invalid |
| heap- | heap- | invalid | [symbol] | [symbol] | N/A | heap- | [symbol] |
| malloc | malloc | | | | | malloc | |
| heap-new | heap-new | [symbol] | invalid | [symbol] | N/A | heap-new | [symbol] |
| heap- | heap- | [symbol] | [symbol] | invalid | N/A | heap- | [symbol] |
| new[ ] | new[ ] | | | | | new[ ] | |
| ownerM. | [symbol] on | [symbol] | [symbol] | [symbol] | N/A | ownerM. | [symbol] |
| | write | | | | | | |

This naturally leads to a notion of ownership of pointers that is a common programming idiom. Thus, we introduce a new status ownerMutable. Prior work used transferable ownership models to find memory leaks in C++ code. However, we only consider C-strings obtained from C++-strings. Thus, we limit ourselves to a non-transferable ownership model, which tracks the relationship between originating C++-string and owned C-string. This allows us to declare such ownerMutable strings as stale (that is, invalid), when the originating C++ object that owns it is modified using a method call.

We summarize the pointer and string object validity checker in Table 1. It shows the effect of various operations in the client code on the defined validity statuses. The handling of many operations including initialization, allocation, destructor calls and so on are omitted from the table in order to avoid clutter.

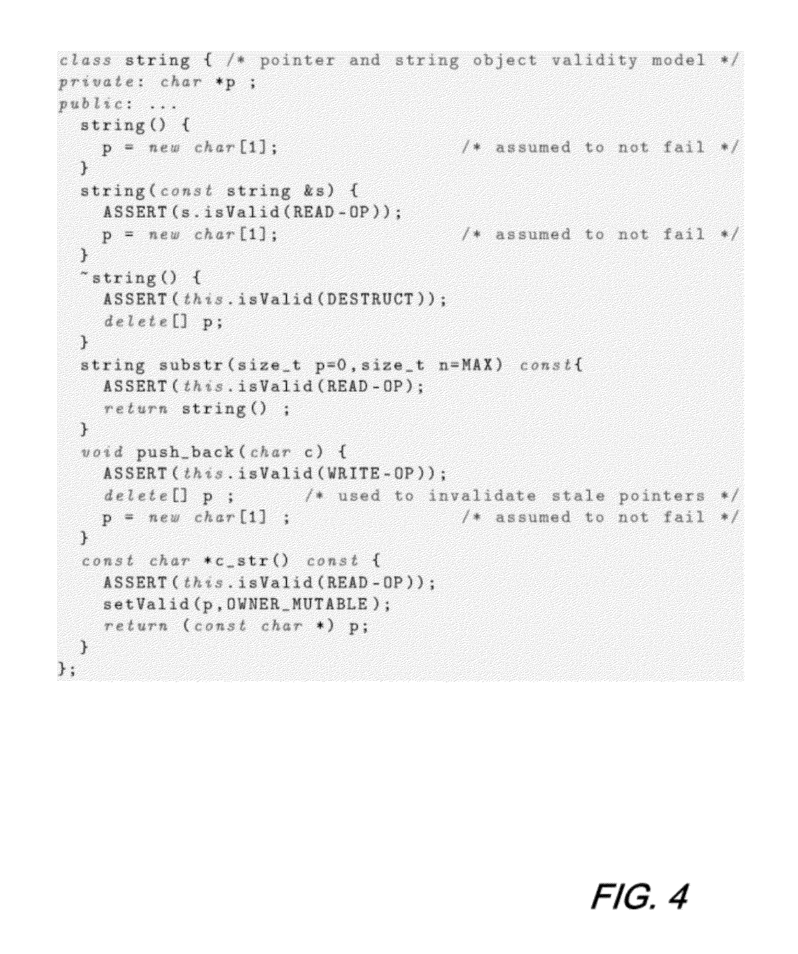

FIG. 4 shows a partial sketch of our custom string object validity model. The internal assertion checks are represented as calls to a member function is Valid(operation), which can be thought of as utilizing the information in Table 1. The sketch shows the use of a setValid(void*,status) method that can be thought of as setting the validity status for arbitrary pointers. The non-const function push_back(c) shows how we invalidate C-strings that may have been obtained through c_str( ) earlier. Finally, note that we separate the issue of allocation failures through new from the string validity checking. As mentioned in the comments, we assume that each new operation succeeds.

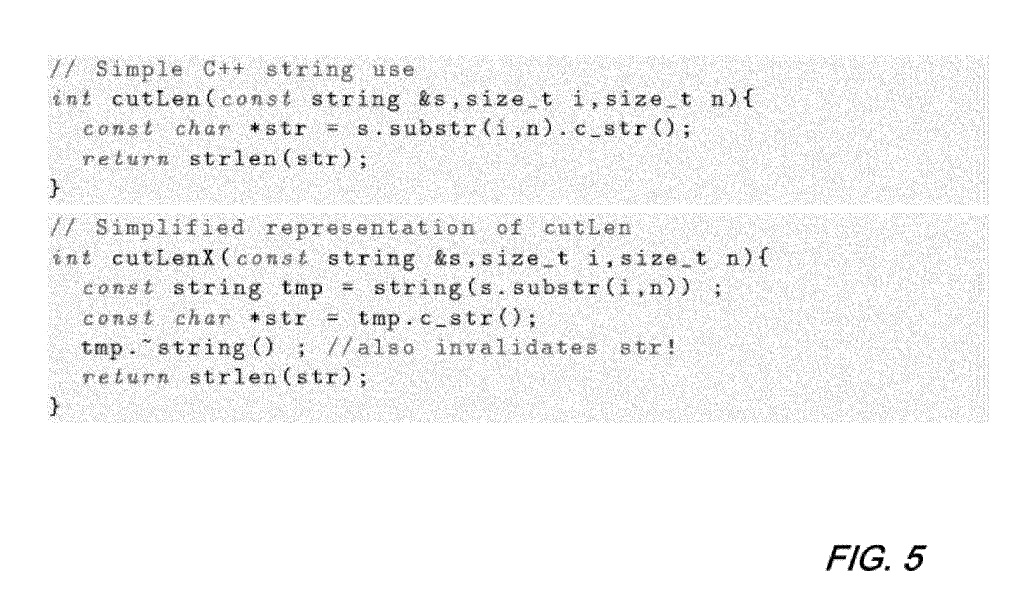

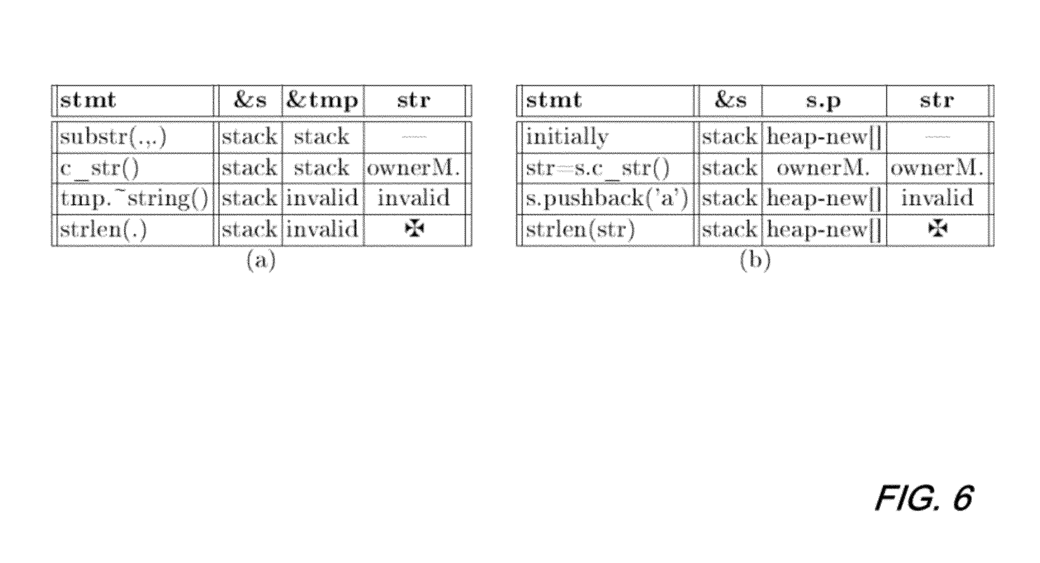

FIG. 5 shows a simple C++ function that manipulates a C++ string and converts it to a C string. It proceeds to call strlen on this C string. A variety of intermediate transformations are performed on the C++ source code including transformations that make calls to constructors and destructors explicit. FIG. 4 also shows the result of this transformation for method cutLen, which we call cutLenX. Note the use of a temporary variable as a result of our transformation, which is initialized using the copy-constructor, and then destroyed using an explicit call to string( ). The bug in the code can thus be detected using the model of FIG. 4 (see FIG. 6(a)).

### Pointer and String Bounds Model

The array bounds model for C strings is extended by tracking the logical size of each C++ string. This size is used to handle calls to string::c_str( ) and string::data( ) Therein, we create valid C strings of the appropriate string length and allocation size, and null-termination status.

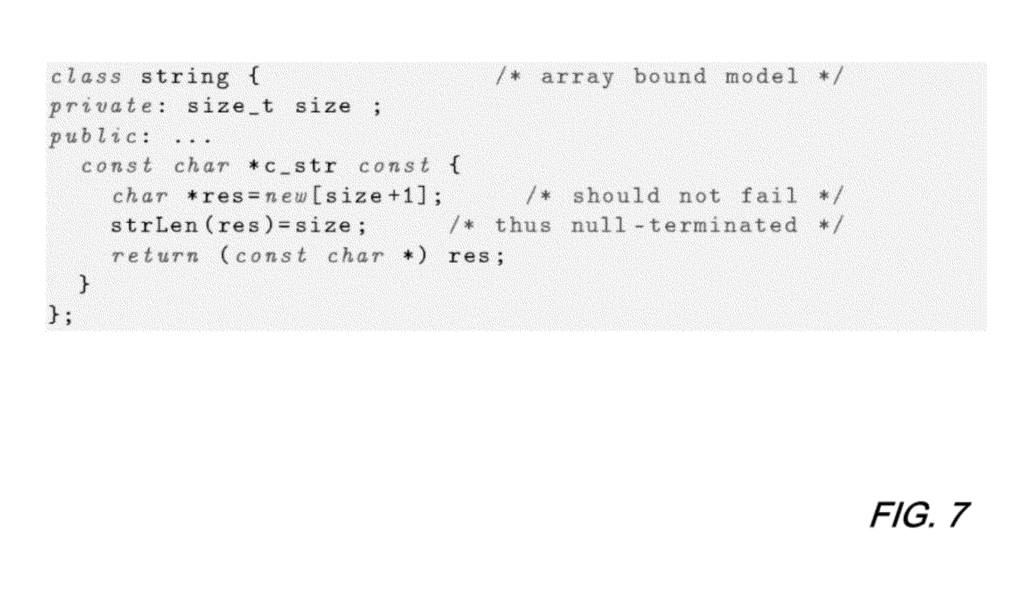

FIG. 7 shows a simplified model for the c_str( ) method. Note that we do not check whether the string object is valid during calls to c_str( ) in this checker. These checks are already performed in the pointer validity model. Similarly, we do not worry that this model leaks memory for calls to c_str( ) since it is only used for ABC. It should be highlighted that due to the use of the efficient validity checker, we can simplify the model for the array bound checking model to only consider the size abstraction. Issues that are related to failed allocations are, as mentioned before, relegated to the special purpose exception checker.

### Experiments

We have implemented our methods in an in-house extension of CIL called CILpp, which handles C++ programs. We present a number of experiments on some C and C++ benchmarks, and describe some of the previously unknown bugs in C++ programs discovered by our analysis.

### Modeling Complex C++ Features

For sake of brevity, we omit discussion of other relevant issues such as initialization sequences, templates, handling of references, and others. Our framework, however, can handle all aspects of the current C++ standard.

### Handling of (Multiple) Inheritance and Virtual Dispatch.

One important issue in the handling of C++ programs is the complexity of class hierarchies. Inheritance, especially multiple inheritance, introduces two main issues while (a) reasoning about class member accesses, and (b) resolving the targets of virtual function calls. For complex class hierarchies, compilers resolve the dynamic virtual dispatch at runtime.

Standard modeling of these features uses field offsets, virtual table lookup pointers, and runtime libraries to maintain runtime type information. Such translations are geared for runtime performance and small memory footprint. As such, they are less amenable for program analysis because program analysis algorithms do not perform well in the presence of table lookups and runtime libraries. Reasoning about arrays of function pointers is often a key failing of many static analysis frameworks.

In our approach, we perform transformations that remove inheritance present in the original C++ program and results in a modified C++ program without the use of inheritance. Note that the transformed source code is not optimized for runtime performance or small memory footprint. The primary goal is in fact ease of static program analysis. Specifically, our transformations enable us to analyze C++ programs in a simplified manner without requiring a new dedicated static analysis or model checking engine.

We use the so-called Rossie-Friedman model of sub-objects to transform a given C++ program with multiple inheritance into an equivalent C++ program that does not contain inheritance. The base class part of a derived class instance is referred to as a sub-object. The translation views an object as a collection of its sub-objects and no assumptions are made about the layout of the fields in each class. Whenever an object is created, the sub-objects that belong to the class are created independently, and are linked to each other via additional pointer fields. During the translation, we avoid the use of virtual pointer tables—this simplifies the analysis of these programs.

Consider the replicated inheritance hierarchy in ReplicatedMultInh. ChromeForReplicatedMultInh shows our object model representation for an instance of class B. The different sub-objects of the class are constructed separately and are connected to each other through the additional pointers. For example, the dervL and baseT pointers connect the sub-objects [B, [symbol] B,L [symbol] )] and [B, [symbol] B,L,T [symbol] )], which refer to the sub-object of class B containing members of base class L, and to the sub-object of class B containing members of the base class T on the path B→L→T.

These auxiliary object hierarchy edges are utilized by our transformation to walk the object when arbitration of inheritance-related features is called for. This happens, for example, when resolving virtual function calls. As another example, consider casts, wherein instead of computing pointer offsets we are able to follow the proper path in the representation of the sub-object model.

This model seamlessly integrates with the partially field-sensitive memory model for C programs discussed earlier. Further details on the transformation mechanism are beyond the scope of this disclosure.

### Exceptions

Exceptions are an important error handling aspect of many programming languages. Exceptions are often used to indicate unusual error conditions during the execution of an application (resource exhaustion, for instance) and provide a way to transfer control to a special purpose exception handling code. The exception handling code deals with the unusual circumstance and either terminates the program or returns control to the non-exceptional part of the program.

Program analysis techniques rely on both intra-procedural and inter-procedural control flow graph information, which are utilized to compute relevant information as needed. However, exceptions introduce additional, and often complex, control flow into the program, in addition to the standard non-exceptional control flow. Therefore, program analysis tools need to compute information about such exceptional flow and incorporate it into their analysis modules to correctly analyze programs containing exceptions.

Previously, we have proposed a modular abstraction for capturing the inter-procedural control flow induced by exceptions in C++, called the inter-procedural exception control flow graph (IECFG). The IECFG is constructed through a sequence of steps, with each step refining it. The design of IECFG is motivated by the need to model implicit calls to destructors during stack unwinding, when an exception is thrown. We use the results of the exception analysis to generate exception-free C++ code. This transformation does not use non-local jumps or calls into opaque C++ runtime systems. Absence of such features enables existing static analyses and verification tools to work soundly over C++ programs with exceptions, without needing to model them explicitly within their framework. More details about our handling of exceptions can be found in our previous work.

The models described thus far are able to find a wide variety of memory related issues in C/C++ source code. Since the focus of this paper is on the modeling of the interaction of C and C++ strings, we first present experiments that target only this particular aspect. To do so, we have performed experiments on open-source software packages that contain such interactions. Our analysis is performed in a scope-bounded fashion. A simple pre-processing technique is used to identify potential error sites. For the interaction analysis, these are centered around calls to string library functions and error-prone functions such as calls to the string::c_str( ) method. This enables us to choose a set of objects and methods to be analyzed. We present a number of bugs that have been uncovered by our experiments, thus far. As our tool is being improved, we are applying our techniques to more open-source software.

### Motivating Example

Recall the code fragment presented as FIG. 1. The released version of the GNU binutils package at the time of the experiments was v2.21 (official releases are available at ftp.gnu.org/gnu/binutils), which was released in December 2010. The bug described earlier was already present in v2.20 released in October 2009. Our tool discovered the bug in March 2011. The developers of the gold package confirmed this bug. However, the developers have been aware of this bug internally about a month before our report. A fix for this bug was finally released with v2.21.1 in June 2011.

Stale Uses of c_str-Created C-Strings

In our experiments, we found that the issue of dangling pointer accesses due to stale uses of C++-to-C converted strings is the main bug category of interest. We have found many incarnations of this bug pattern in addition to the motivating example, which can be found using the validity-based abstraction model.

We have observed the same issue in a variety of other open-source benchmarks, including in unit tests for ICU4C, which provides portable unicode handling capabilities for software globalization requirements. Similarly, we noticed three uses of a dangling C-string pointer obtained through string::c_str( ) in Mosh, a fast interpreter for Scheme as specified in R6RS, which is the latest revision of the Scheme standard. After we informed the developers of this actively maintained project about these three dangling pointer violations, they have confirmed the issue and have fixed them in the source repository.

Manipulation of ownerMutable Strings

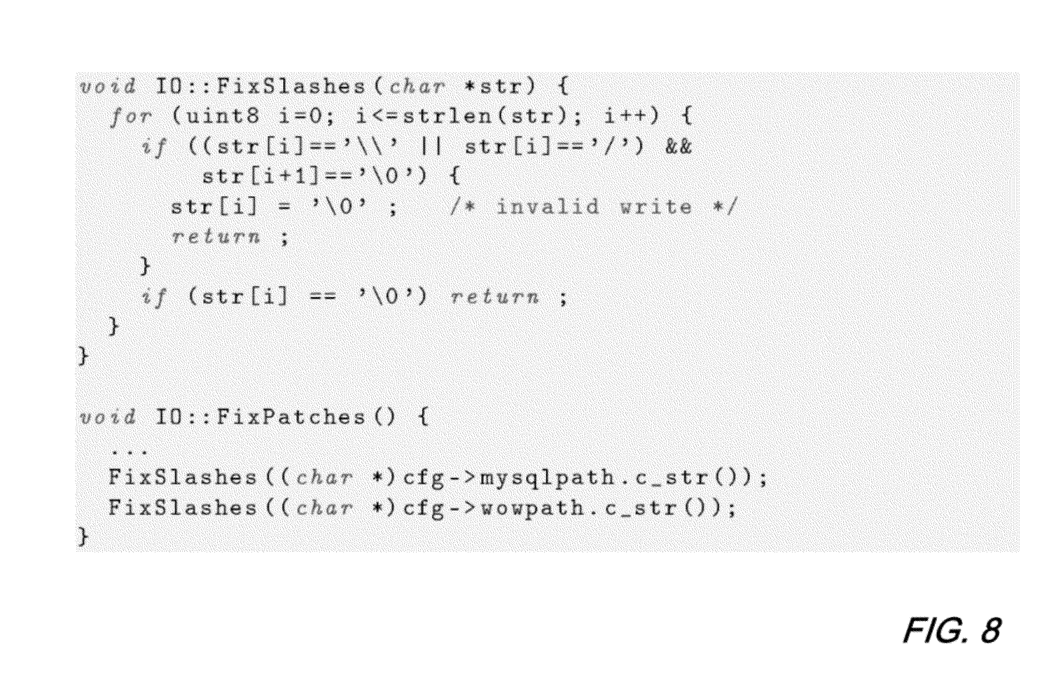

We also observed rare cases of direct string manipulation of C-strings obtained through c_str( ). As discussed earlier, this is in explicit violation of the STL C++ string specification. Multiple such scenarios occurred in the datatrap project, one of which is shown in FIG. 8.

### Buffer Overflows Due to String Conversions

In our experiments, we have also observed rare cases of potential buffer overflows using strings obtained from a C++ string object. One such example is shown in FIG. 8, which is from a library that transliterates text between different representations. Note that this warning awaits confirmation, since in our scope-bounded analysis we are not aware of any global constraint on the maximum size of a string to be converted.

### Erlang/OTP Case Study

Erlang is a programming language used to build massively scalable soft real-time systems with requirements on high availability. Erlang's runtime system has built-in support for concurrency, distribution and fault tolerance. OTP is a set of Erlang libraries providing middle-ware to develop such systems. It includes a distributed database, applications to interface towards other languages, debugging tools, etc.

We analyzed relevant C and C++ source code of the current Erlang/OTP release R14B01 (December 2010). The Orber application is a CORBA compliant Object Request Broker (ORB), which provides CORBA functionality in an Erlang environment. Essentially, the ORB channels communication or transactions between nodes in a heterogeneous environment.

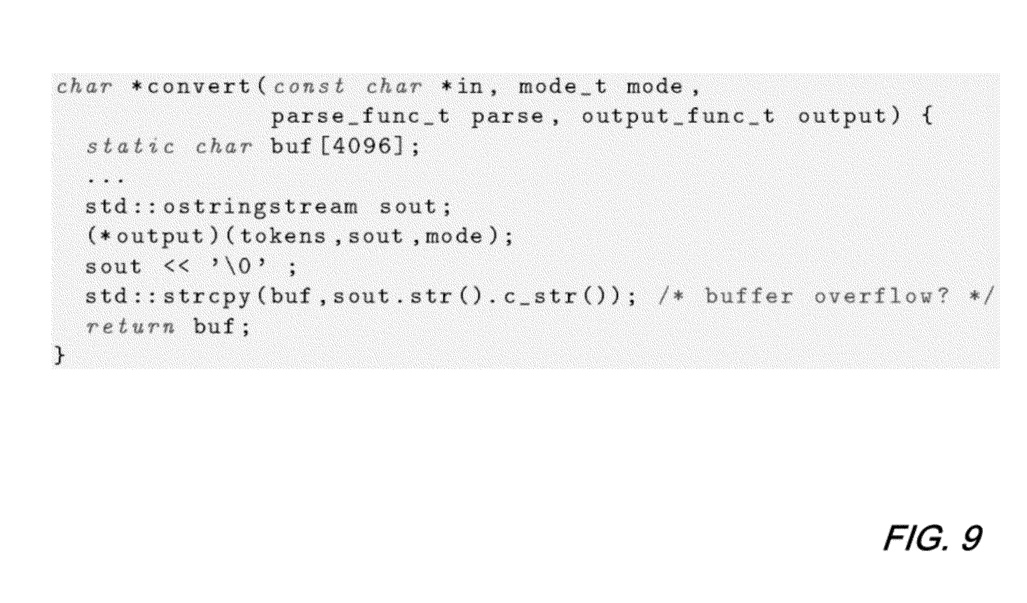

FIG. 9 shows a part of the C++ source code for the InitialReference class in Orber. The code generates a reference for an Interoperable Object Reference (IOR), which simplifies the initial reference access from C++. However, the C++ interface contains a number of invalid uses of C-strings from a C++ string object in the central createIOR method. Our analysis discovered the invalid access inside the for-loop, and also reported the invalid call to delete.

We analyzed the complete C++ code inside the Orber module. As is typical for C++, complexity of the analysis is increased due to standard header files. While the Orber module only contained about 300 LOC, the effective LOC after including the relevant headers is about 3 k LOC. Our tool analyzed 7 functions of interest, and reported only the above 2 witnesses using the pointer and string object validity checker. The array bound checker did not find any witnesses in this case study. For one of the functions, the analysis using abstract interpretation and bounded model checking timed out (we limit the analysis for each function to 10 minutes). Overall, for 14 function and checker pairs, our tool reported over 40 property proofs, and spent about 20 minutes for the analysis.

However, our tool did not report a third issue, where a dangling pointer is assigned to the iorString member field. We discovered this issue when inspecting neighboring code to reported warnings. This likely violation of the object invariant, that all member fields be pointing to valid memory regions, was not discovered since our scope-bounded analysis did not find a read of the iorString field. In the future, we would like to extend our analysis to automatically check for object consistency after method invocations, in order to discover such issues.

The c-icap Project

The c-icap project is an open-source implementation of ICAP (Internet Content Adaptation Protocol), a protocol aimed at supporting HTTP content adaptation. ICAP allows arbitrary content-filtering and on-the-fly content modification. A common application running ICAP are anti-virus scanners, for example. The development of the c-icap project started in 2004, and the project is still actively maintained.

TABLE 2
Experimental results for c-icap for various checkers

| Bug | | | | | |
|---|---|---|---|---|---|
| category | Checker | Reported | Known | Fixed | Important |
| NULL | PVC | 23 | 0 | 22 | 1 |
| access | | | | | |
| Memory | MLC | 7 | 1 | 6 | 0 |
| leak | | | | | |
| Uninitialized | UUM | 2 | 0 | 2 | 1 |
| condition | | | | | |
| Array | ABC | 1 | 0 | 1 | 0 |
| underflow | | | | | |
| Partially | UUM | 1 | 0 | 1 | 1 |
| initialized | | | | | |
| memory | | | | | |
| Total | | 34 | 1 | 32 | 3 |

We analyzed the complete c-icap project with our tool, by analyzing individual modules separately. The tool analyzed over 24 k lines of source code written in C, which includes about 4 k lines of header files. The complete analysis, in a scope-bounded fashion, using abstract interpretation and model checking for all checkers completes in a few hours. The full investigation of all witnesses found by the model checker took one expert user about 3 hours.

The experimental results are summarized in Table 2. The investigation yielded 34 unique bugs that were communicated to the developer of c-icap. 32 of the 34 reported issues have been fixed so far. Three of the reported bugs were deemed very important by the developer, including one deep inter-procedural NULL access. The two bugs that have not been fixed yet have been acknowledged as bugs as well, and are to be addressed in future releases.

### The MeCab Project

The MeCab project provides a customizable Japanese morphological analyzer, which is applied to a variety of natural language processing tasks. Its source code (without any header files) contains 6.6 k LOC of C++ code. A verification engineer discovered four bugs using this approach. This includes 3 paths with invalid NULL accesses, which were found using the pointer validity checker. Additionally, one uninitialized memory read was discovered.

While we have described particular aspects of the present disclosure using specific examples those skilled in the art will readily appreciate that the disclosure is not so limited. Accordingly, the disclosure should be viewed as limited only by the scope of the claims that follow.

1. A computer implemented method for analyzing a computer software program which utilizes both C++ and C string operations, said method comprising the steps of:
building a memory model abstraction of any memory used by such strings and string objects;
modeling the conversion from a C++ string to a C string using a non-transferable ownership attribute that is to be respected by so-tagged C strings;
verifying the model with respect to safe usage; and
outputting any violations.

2. The computer implemented method of claim 1 wherein the memory model is a pointer validity model.

3. The computer implemented method of claim 1 wherein the memory model is a pointer bounds model.

4. The computer implemented method of claim 2 wherein the pointer validity model instruments, for each object, pointer, reference, heap location, and stack location, a validity status which denotes the type of a location pointed to in memory.

5. The computer implemented method of claim 3 wherein the pointer bounds model tracks various attributes for each pointer including: ptrLo(p), which corresponds to the base address of a memory region that p currently points to; ptrHi(p), which corresponds to the last address in the memory region currently pointed to by p that can be accessed without causing a buffer overflow; and strLen(p), which corresponds to the remaining string length of the pointer p, which is the distance to the next null-termination symbol starting at p; and for each pointer p, its address and its bounds are tracked.

6. The computer implemented method of claim 1 wherein the non-transferable ownership attribute tracks the relationship between the C++ string and the resulting, owned, C string.

7. The computer implemented method of claim 4 wherein the analysis of the model is performed using an abstract interpretation.

8. The computer implemented method of claim 4 wherein the analysis of the model is performed using model checking.

9. The computer implemented method of claim 4 wherein the analysis of the model is performed using bounded model checking.

10. The computer implemented method of claim 4 wherein the analysis of the model is performed using dynamic analysis techniques.

11. A computer implemented method for analyzing a computer software program which utilizes both C++ and C string operations, said method comprising the steps of:
checking for runtime violations of programs wherein conversion from a C++ string to a C string generates a non-transferable ownership attribute that is to be respected by so-tagged C strings;
executing the program; and
outputting any observed violations during the execution.

12. The computer implemented method of claim 11 wherein the non-transferable ownership attribute tracks the relationship between the C++ string and the resulting, owned, C string.

13. The computer implemented method of claim 12 wherein the observed violations are an indication of pointer validity violations.

14. The computer implemented method of claim 12 wherein the observed violations are an indication of pointer bounds violations.

15. The computer implemented method of claim 13 further comprising the instrumentation, for each object, pointer, reference, heap location, and stack location, a validity status which denotes the type of a location pointed to in memory.

16. The computer implemented method of claim 14 further comprising the tracking of various attributes for each pointer including: ptrLo(p), which corresponds to the base address of a memory region that p currently points to; ptrHi(p), which corresponds to the last address in the memory region currently pointed to by p that can be accessed without causing a buffer overflow; and strLen(p), which corresponds to the remaining string length of the pointer p, which is the distance to the next null-termination symbol starting at p; and for each pointer p, its address and its bounds are tracked.

17. A computer implemented system for analyzing a computer software program which utilizes both C++ and C string operations, said system comprising:
a modeler for the program and its memory wherein conversion from a C++ string to a C string generates a non-transferable ownership attribute that is to be respected by so-tagged C strings; and
a checker for detecting runtime violations of programs and outputting any observed violations.

18. The computer implemented system of claim 17, wherein the non-transferable ownership attribute tracks the relationship between the C++ string and the resulting, owned, C string.

19. The computer implemented system of claim 17, wherein the checker uses abstract interpretation.

20. The computer implemented system of claim 17, wherein the checker uses model checking.
